(19) United States
(12) Patent Application Publication
(10) Pub. No.: US 2013/0001380 A1
(43) Pub. Date: Jan. 3, 2013

(54) Compressed Gas Cylinder Stand

(75) Inventor: Jacob Anthony Guillory, Sweetwater, TX (US)

(73) Assignee: GENERAL ELECTRIC COMPANY, Schnectady, NY (US)

(21) Appl. No.: 13/172,905

(22) Filed: Jun. 30, 2011

(51) Int. Cl. F16M 11/00

(52) U.S. Cl. 248/146

(57) ABSTRACT

The present application provides a compressed gas cylinder stand for use with a compressed gas cylinder. The compressed gas cylinder stand may include a solid body with a cone-like shape and an aperture through the solid body. The aperture may be sized to accommodate the compressed gas cylinder.

### TECHNICAL FIELD

The present application and the resultant patent relate generally to a support stand for elongated cylindrical objects and more particularly relate to a support stand for compressed gas cylinders and the like so as to reduce the chances of tipping for increased safety.

### BACKGROUND OF THE INVENTION

Numerous types of gases are commonly stored in compressed gas cylinders. A compressed gas cylinder generally includes a metallic cylindrical body with a valve and a pressure gauge. The gasses therein are stored under very high pressures. As such, a breach or other damage to the compressed gas cylinder could have catastrophic results.

The storage and use of compressed gas cylinders thus is subject to governmental regulation such as those promulgated by the U.S. Occupational Safety and Health Administration (“(OSHA”) as well as industry standards such as those promulgated by the American National Standards Institute (“ANSI”) and the like. For example, compressed gas cylinders are to be secured in an upright position as all times. Moreover, a suitable cylinder truck, chain, or other type of “steadying device” shall be used to keep the compressed gas cylinders from being knocked over while in use. See, e.g., OSHA Regulation 1926.350(a). The specifics of such a cylinder truck, a chain, or a “steadying device,” however, generally are not defined in the regulations. As such, there is little uniformity in the field. Moreover, “steadying devices” employed when the compressed gas cylinder is in use may not be adequate for long term storage of the compressed gas cylinder.

There is thus a desire for an improved support stand for adequately supporting and steadying compressed gas cylinders and the like. Such an improved support stand should be easy to use while also being adequate for both safe usage and safe storage.

### SUMMARY OF THE INVENTION

The present application and the resultant patent thus provide a compressed gas cylinder stand for use with a compressed gas cylinder. The compressed gas cylinder stand may include a solid body with a cone-like shape and an aperture through the solid body. The aperture may be sized to accommodate the compressed gas cylinder therethrough.

The present application and the resultant patent thus provide a compressed gas cylinder stand for use with a compressed gas cylinder. The compressed gas cylinder stand may include a solid body made of a thermoplastic material, an aperture through the solid body with the aperture sized to accommodate the compressed gas cylinder such that the solid body can slide over the compressed gas cylinder, and the solid body may include one or more handles formed therein.

The present application and the resultant patent may include a compressed gas cylinder stand for use with a compressed gas cylinder. The compressed gas cylinder may include a body having a shell with a filler therein and an aperture through the body. The aperture may be sized to accommodate the compressed gas cylinder such that the body can slide over the compressed gas cylinder.

These and other features and advantages of the present application and the resultant patent will become apparent to one of ordinary skill in the art upon review of the following detailed description when taken in conjunction with the several drawings and the appended claims.

### BRIEF DESCRIPTION OF THE DRAWINGS

FIG. 1 is a side plan view of a compressed gas cylinder.

FIG. 2 is a side plan view of a compressed gas cylinder stand as may be described herein.

FIG. 3 is a top plan view of the compressed gas cylinder stand of FIG. 2.

FIG. 4 is a cross-section view of an alternative embodiment of a compressed gas cylinder stand as may be described herein.

FIG. 5 is a side plan view of the compressed gas cylinder stand being placed on a compressed gas cylinder.

FIG. 6 is a side plan view of the compressed gas cylinder stand supporting a compressed gas cylinder.

### DETAILED DESCRIPTION

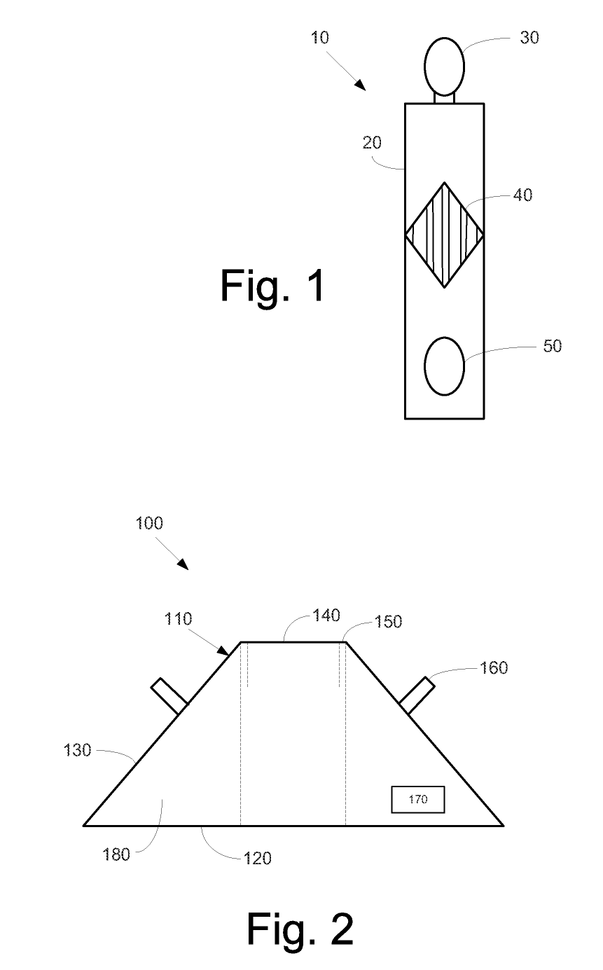

Referring now to the drawings, in which like numerals refer to like elements throughout the several views, FIG. 1 shows a compressed gas cylinder 10. The compressed gas cylinder 10 has an elongated cylindrical body 20 with a valve 30 on one end. The cylindrical body 20 may be made out of steel or other types of metals and alloys that can withstand the high pressures of the gasses therein. The length, diameter, and configuration of the cylindrical body 20 may vary. The valve 30 may be of conventional design. A pressure gauge also may be used. Identifying indicia 40 may be present on the cylindrical body 20. Any type of pressurized gases may be used herein under conventional pressures. Other configurations and other components may be used herein.

The compressed gas cylinder 10 generally has a low center of gravity 50. As a result, tipping the compressed gas cylinder 10 may be possible with relatively little force. As described above, damage to the compressed gas cylinder 10 thus is a known workplace hazard.

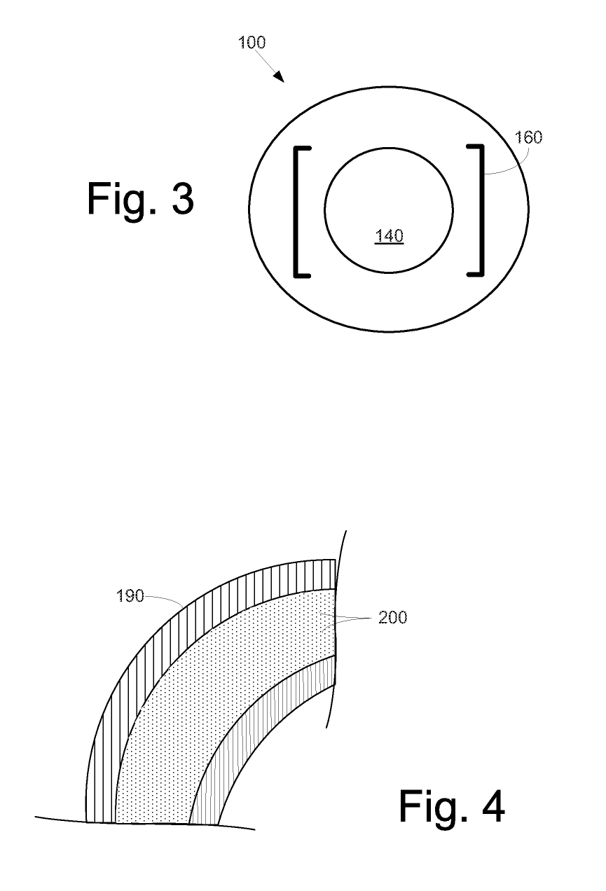

FIGS. 2 and 3 show and example of a compressed gas cylinder stand 100 as may be described herein. The compressed gas cylinder stand 100 may have a substantial cone-like shape 110. Other shapes such as cylinders, squares, and the like also may be used. Specifically, any structure that has a base 120 with a sufficient length and an overall sufficient mass to support the compressed gas cylinder 10 may be used herein. The compressed gas cylinder stand 100 likewise has a height 130. As with the base 120, the height 130 may vary based upon the size of the specific compressed gas cylinder 10. The compressed gas cylinder stand 100 includes an aperture 140. The aperture 140 also may be sized for a specific compressed gas cylinder 10 with the addition of a small positioning gap 150. The compressed gas cylinder stand 100 also may include one or more handles 160 thereon. The handles 160 may be attached via fasteners and/or molded into place. The compressed gas cylinder stand 100 may have different types of messaging indicia 170 thereon. The messaging indicia 170 may include company information, safety information, size information, use information, information on the gases therein, and the like. If a thermoplastic or other type of moldable material is used, the messaging indicia 170 may be formed therein. Other components and other configurations may be used herein.

The compressed gas cylinder stand 100 may be made out of thermoplastics, rubber, metals, alloys, combinations thereof, and the like. The material may be a recyclable material. The compressed gas cylinder stand 100 may be a solid body 180. The solid body 180 may be uniform throughout. Alternatively as is shown in cross-section in FIG. 4, the solid body 180 may have an outer shell 190 and a filler material 200 therein. The filler material 200 may be used for additional mass. Insulation or no-thermally conductive materials may be used with compressed gas cylinders 10 using cryogenic gases and the like. The compressed gas cylinder stand 100 may be made out of a high visibility color for safety. Likewise, other types of safety features such as flags and the like also may be used. Multiple compressed gas cylinder stands 100 may be attached to each other for further stability.

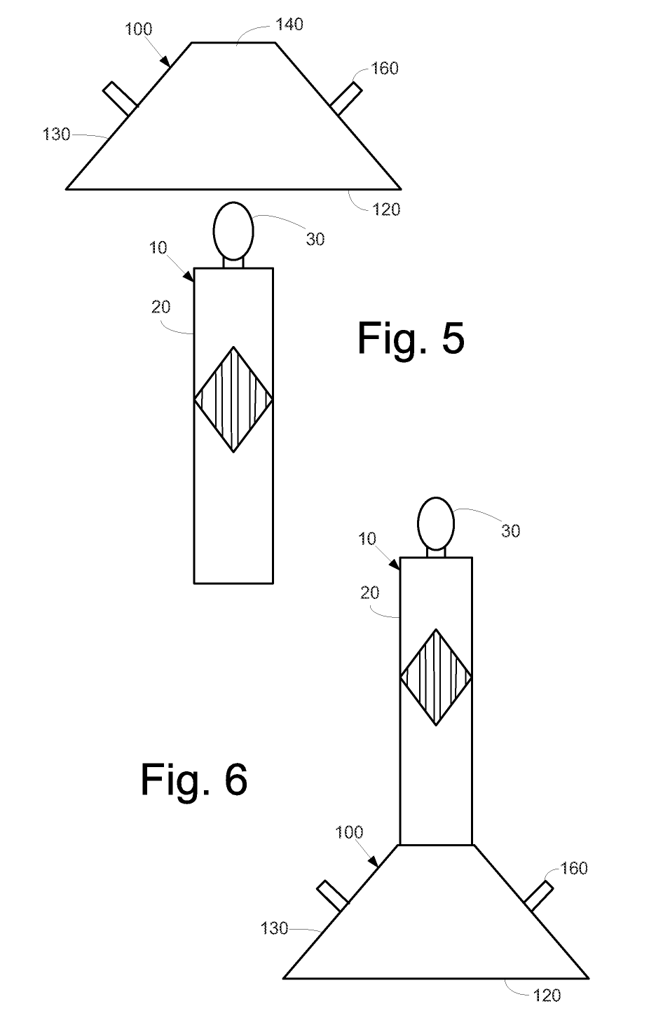

FIG. 5 shows the positioning of the compressed gas cylinder stand 100 on the compressed gas cylinder 10. As described above, the aperture 140 is sized with the gap 150 to accommodate the diameter of a specifically sized compressed gas cylinder 10. As is shown in FIG. 6, the compressed gas cylinder stand 100 surrounds and supports the bottom of the compressed gas cylinder 10. The base 120 of the compressed gas cylinder stand 100 provides considerably more mass to the combination of the compressed gas cylinder 10 and the compressed gas cylinder stand 100 such that significantly more force would be required to tip over the compressed gas cylinder 10. The compressed gas cylinder stand 100 thus adequately steadies the compressed gas cylinder 10 while in use and also provides safe long term storage.

Multiple compressed gas cylinder stands 100 thus may have differing sizes, shapes, and configurations based upon the size, shape, and configuration of the compressed gas cylinder 10 intended to be used therewith. The compressed gas cylinder stand 100 thus provides increased safety when using and storing compressed gas cylinders 10. The compressed gas cylinder stand 100) also may be used for transporting a compressed gas cylinder 10.

It should be apparent that the foregoing relates only to certain embodiments of the present application and the resultant patent. Numerous changes and modifications may be made herein by one of ordinary skill in the art without departing from the general spirit and scope of the invention as defined by the following claims and the equivalents thereof.

I claim:

1. A compressed gas cylinder stand for use with a compressed gas cylinder, comprising:
a solid body;
the solid body comprising a cone-like shape; and
an aperture through the solid body;
the aperture sized to accommodate the compressed gas cylinder.

2. The compressed gas cylinder stand of claim 1, wherein the aperture comprises an additional gap.

3. The compressed gas cylinder stand of claim 1, wherein the solid body comprises one or more handles thereon.

4. The compressed gas cylinder stand of claim 1, wherein the solid body comprises messaging indicia thereon.

5. The compressed gas cylinder stand of claim 1, wherein the solid body comprises a high visibility color.

6. The compressed gas cylinder stand of claim 1, wherein the solid body comprises a thermoplastic material.

7. The compressed gas cylinder stand of claim 1, wherein the solid body comprises a rubber material.

8. The compressed gas cylinder stand of claim 1, wherein the solid body comprises a recyclable material.

9. The compressed gas cylinder stand of claim 1, wherein the solid body comprises a shell with a filler therein.

10. The compressed gas cylinder stand of claim 1, wherein the solid body comprises a base and a height.

11. The compressed gas cylinder stand of claim 10, wherein the base comprises a first length, the height comprises a second length, and wherein the first length is greater than the second length.

12. The compressed gas cylinder stand of claim 1, wherein the solid body comprises a non-thermally conductive material.

13. The compressed gas cylinder stand of claim 1, wherein the aperture is sized such that the solid body can slide over the compressed gas cylinder.

14. The compressed gas cylinder stand of claim 1, further comprising a plurality of connected solid bodies.

15. A compressed gas cylinder stand for use with a compressed gas cylinder, comprising:
a solid body;
the solid body comprising a thermoplastic material;
an aperture through the solid body;
the aperture sized to accommodate the compressed gas cylinder such that the solid body can slide over the compressed gas cylinder; and
the solid body comprising one or more handles formed therein.

16. The compressed gas cylinder stand of claim 15, wherein the solid body comprises a shell with a filler therein.

17. The compressed gas cylinder stand of claim 15, wherein the solid body comprises messaging indicia thereon.

18. The compressed gas cylinder stand of claim 15, wherein the solid body comprises a high visibility color.

19. The compressed gas cylinder stand of claim 15, wherein the solid body comprises a base with a first length, a height with a second length, and wherein the first length is greater than the second length.

20. A compressed gas cylinder stand for use with a compressed gas cylinder, comprising:
a body;
the body comprises a shell with a filler therein; and
an aperture through the body;
the aperture sized to accommodate the compressed gas cylinder such that the body can slide over the compressed gas cylinder.
